(19) United States
(12) Patent Application Publication
(10) Pub. No.: US 2018/0354213 A1
(43) Pub. Date: Dec. 13, 2018

(54) Method of Manufacturing Coated Silicone Hydrogel Contact Lenses

(71) Applicant: CooperVision International Holding Company, LP, St. Michael (BB)

(72) Inventors: Victoria Tran, San Leandro, CA (US); Victoria Rogers, Pleasanton, CA (US)

(73) Assignee: CooperVision International Holding Company, LP, St. Michael (BB)

(21) Appl. No.: 15/961,905

(22) Filed: Apr. 25, 2018

Related U.S. Application Data
(60) Provisional application No. 62/518,621, filed on Jun. 13, 2017.

(51) Int. Cl. B29D 11/00; G02C 7/04; G02B 1/00

(52) U.S. Cl. CPC B29D 11/00038; G02B 1/00; G02C 7/04

(57) ABSTRACT

Contact lenses having even surface coatings are manufactured by coating a polyvinyl alcohol polymer on a lens-forming surface of a contact lens mold, applying a contact lens coating composition onto the polyvinyl alcohol polymer, and curing a contact lens formulation in the coated contact lens mold. During curing, the coating composition transfers from the mold to the contact lens surface. The polyvinyl alcohol helps prevent the contact lens coating composition from being solubilized by the contact lens composition during the curing step.

This application claims the benefit under 35 U.S.C. § 119(e) of prior U.S. Provisional Patent Application No. 62/518,621, filed Jun. 13, 2017, which is incorporated in its entirety by reference herein.

### FIELD

The field of the invention relates to the manufacture of coated contact lenses.

### BACKGROUND

Mold transfer of beneficial agents to a cast-molded contact lens can be advantageous in that it can provide a surface coating on the contact lens that has a high concentration of the beneficial agent while allowing the bulk of the lens to be un-impacted by the beneficial agent. In order to mold transfer effectively, however, numerous conditions must be satisfied. For instance, the coating material must spread properly on the mold. Further, the beneficial agent material must transfer to the lens surface during curing. However, the beneficial agent may be too miscible with the curable contact lens formulation and the two may mix, resulting in a contact lens that has the beneficial agent in its bulk rather than at the surface and/or resulting in a contact lens that is improperly cured or deformed due to the effect of the beneficial on the bulk properties of the contact lens.

New methods are needed for the mold transfer of beneficial agents that may not readily spread on contact lens molds or that may absorb into a contact lens composition during curing.

Background publications include U.S. Pat. No. 8,801,176; U.S. Pat. No. 6,719,929; U.S. Pat. No. 6,890,075; U.S. Pat. No. 7,879,267; U.S. Pat. No. 6,310,116; U.S. Pat. No. 5,779,943; U.S. Pat. Publ. No. 2009/0200692; U.S. Pat. Publ. No. 2007/0120279; U.S. Pat. Publ. No. 2008/0001317; U.S. Pat. Publ. No. 2016/0159019; and Japanese Pat. No. 5,631,655.

### SUMMARY

In one aspect, the invention provides a method of manufacturing a coated contact lens. The method comprises coating a polyvinyl alcohol polymer on at least a portion of a lens-forming surface of a contact lens mold, applying a contact lens coating composition onto the polyvinyl alcohol polymer to provide a coated contact lens mold, and curing a contact lens formulation in the coated contact lens mold to form a contact lens comprising a polymeric lens body and a surface coating attached to the polymeric lens body. The surface coating of the contact lens comprises at least one component of the contact lens coating composition. In certain examples, the surface coating is substantially free of polyvinyl alcohol polymer.

In a further aspect, the invention provides a silicone hydrogel contact lens comprising a polymeric lens body and a surface coating comprising a cross-linked acrylic acid polymer attached to the polymeric lens body by an interpenetrating polymer network. In a specific example, the acrylic acid polymer is a particulate polymer having a diameter of at least 0.01 μm.

### DETAILED DESCRIPTION

Methods are provided for manufacturing contact lenses comprising even and durable surface coatings. The method comprises coating a polyvinyl alcohol (PVOH) polymer on at least a portion of a lens-forming surface of a contact lens mold. A contact lens coating composition is applied onto at least a portion of the PVOH polymer coating to provide a coated contact lens mold. A curable contact lens formulation is dispensed into the coated contact lens mold and is cured to form a contact lens comprising a polymeric lens body and a surface coating attached to the polymeric lens body, wherein the surface coating comprises at least one component of the contact lens coating composition. In some examples, the contact lens is washed to provide a surface coating that is substantially free of the PVOH polymer.

Typically, a contact lens mold comprises two combinable parts: a female mold member having a concave lens-forming molding surface that defines the front surface of the contact lens, and a male mold member having a convex lens-forming molding surface that defines the back (i.e. eye-contacting) surface of the contact lens. A curable contact lens formulation is dispensed into the female mold member, which is then joined with the male mold member, such as by an interference fit, gluing, or welding. The resulting contact lens mold assembly has a lens-shaped cavity between the two lens-forming molding surfaces that is filled with a curable contact lens formulation. In some examples, the contact lens mold comprises only one lens-forming surface that defines either the front or the back surface of the contact lens. In such examples, a curable contact lens formulation is cured in the mold to form a polymeric lens body having a cast-molded front or back surface and the other surface is formed by machining (e.g. lathing).

The contact lens mold may be made from any suitable material for molding contact lenses. In one example, the contact lens mold is or comprises a non-polar material. Examples of non-polar materials suitable for forming contact lens molds include polypropylene, cyclic olefinic polymers and copolymers, polyethylene, polystyrene, certain nylon polymers, and the like. In other examples, the contact lens mold may be made from a polar material. Examples of polar materials suitable for contact lens molds includes ethylene vinyl alcohol copolymers, polyamide, polyvinyl alcohol resins having a 1,2-diol structural unit, Nylon 6/6, Nylon 4/6, acetal resin, and polybutylene terephthalate. Additional polar mold materials suitable for contact lens molds are described in U.S. Pat. No. 8,979,261, and U.S. Pat. No. 9,156,214.

In the case of two-part molds, the female and male mold members may be formed from the same or different materials. In one example, one mold member may be formed from a polar material such as an ethylene vinyl alcohol resin or a polyvinyl alcohol resin (see, e.g., EP Pat. No. 2598319B1), and the other mold member may be formed from a non-polar material such as polypropylene. In another example, both mold members are formed from a polar material. In yet another example, both mold members are formed from a non-polar material. In a specific example, the contact lens mold comprises a polypropylene male mold member and a polypropylene female mold member. Throughout this disclosure, a reference to “an example” or “a specific example” or similar phrase, is intended to introduce a feature or features of the contact lens mold, PVOH polymer, contact lens coating composition, contact lens formulation, method of manufacture, etc. (depending on context) that can be combined with any combination of previously-described or subsequently-described examples (i.e. features), unless a particular combination of features is mutually exclusive, or unless context indicates otherwise.

As used herein, the term PVOH polymer refers to PVOH homopolymers and/or PVOH co-polymers. Suitable PVOH polymers are film-forming and water soluble. In a specific example, the PVOH polymer is a PVOH homopolymer and may be fully or partially hydrolyzed. In one example, the PVOH polymer is at least 96%, 98%, or 99% hydrolyzed. The % hydrolysis of PVOH refers to the molar percentage of the acetate groups of the starting polyvinyl acetate molecule that are converted (i.e. hydrolyzed) to alcohol groups during the conversion (i.e. saponification) of polyvinyl acetate to PVOH. In some examples, the PVOH polymer has an average molecular weight of from about 10,000, 25,000, or 50,000 up to about 75,000, 100,000, 125,000, 150,000, or 200,000. In one example, the PVOH polymer is provided as an aqueous solution which is coated onto at least a portion of a lens-forming surface of the contact lens mold. As used herein, a portion of a lens forming surface refers to an area that is at least 5% of the entire surface area of the lens-forming surface of the contact lens mold. In some examples, the PVOH polymer is coated onto at least 10%, 25%, 50%, or 75% of the surface area of the lens-forming surface of the contact lens mold. In a specific example, the PVOH polymer is coated onto an entire lens forming surface of a contact lens mold. The aqueous solution may comprise from about 0.1% by weight (wt. %), 0.5 wt. %, 1 wt. %, or 2 wt. %, PVOH up to about 5 wt. %, 10 wt. %, or 20 wt. % PVOH. Throughout this disclosure, when a series of lower limit ranges and a series of upper limit ranges are provided, all combinations of the provided ranges are contemplated as if each combination were specifically listed. For example, in the above listing of % PVOH, all 12 possible ranges of % PVOH are contemplated (i.e. 0.1% to 5%, 0.1% to 10% . . . 2% to 10%, and 2% to 20%). Further, throughout this disclosure, when a series of values is presented with a qualifier preceding the first value, the qualifier is intended to implicitly precede each value in the series unless context dictates otherwise. For example, for the % PVOH listed above, it is intended that the qualifier “of about” implicitly precedes each of the values 0.5%, 1%, and 2%, and the qualifier “to about” implicitly precedes each of 10% and 20%. The aqueous solution of the PVOH polymer may comprise one or more additives. For example, a surfactant, binder, or other additive may be included in order to facilitate the formation of a thin and even coating of PVOH on the lens-forming surface of the mold.

At least a portion of a lens-forming surface of the contact lens mold is coated with the PVOH polymer. In one example, the PVOH coating covers an entire lens-forming surface of a contact lens mold. In a specific example, the contact lens mold comprises a female mold member and a male mold member, and the PVOH coating entirely covers both of the lens-forming surfaces of the contact lens mold. The PVOH coating may be applied by any suitable coating method such as spray-coating, spin-coating, dip-coating, roll-coating, curtain-coating, chemical vapor deposition, pad-printing and the like. In one example, the PVOH coating is applied to provide a coating that, after drying, has an average thickness of about 0.01 μm, 0.05 μm, 0.1 μm, 0.25 μm, 0.5 μm, or 1.0 μm up to about 2 μm, 5 μm or 100 μm. Coating thickness may be measured using reflectance spectroscopy. The PVOH coating may be dried, such as by air drying or heat drying, prior to application of the contact lens coating composition.

A contact lens coating composition is applied onto at least a portion of the PVOH coating. In one example, an entire lens-forming surface of the contact lens mold is coated with PVOH and the contact lens coating composition is applied onto the entire lens-forming surface of the PVOH-coated contact lens mold. In other examples, an entire lens-forming surface of the contact lens mold is coated with PVOH and the contact lens coating composition is applied onto a portion of the lens-forming surface of the PVOH-coated contact lens mold. In one example, only the portion of the mold that forms the optic zone portion of the contact lens is coated with the contact lens coating composition. In another example, only the portion of the mold that forms the region of the lens corresponding to a wearer's limbal ring is coated with the contact lens coating composition.

The contact lens coating composition comprises at least one component that attaches to the surface of the polymeric lens body during the curing step to provide the contact lens with a surface coating that imparts the contact lens with one or more desired properties or features. Non-limiting examples of properties or features that may be imparted by the component include increased wettability, decreased friction, anti-fouling, antimicrobial activity, light blocking, color (e.g. for cosmetic lenses, handling tints, light blocking etc.), drug-release, and enhanced comfort. In various examples, the component may be or comprise a hydrophilic monomer, a hydrophilic polymer, an amphiphilic polymer, a polymerizable dye, a drug, a comfort agent, an antimicrobial agent, or any combinations thereof. The contact lens coating composition may comprise an organic solvent that does not fully solubilize the PVOH coating, such as ethanol or other suitable solvent. The contact lens coating composition may comprise one or more additional ingredients such as a surfactant, binder, or other additive that may facilitate formation of a coating on top of the PVOH coating.

The contact lens coating composition may be applied onto the PVOH coating using any suitable method, such as one of the methods listed above for application of the PVOH coating. In some examples, the contact lens coating composition comprises one or more reactive or curable components. It may be subjected to conditions after it has been coated onto the PVOH-coated contact lens mold that cause the contact lens coating composition to react or to partially or fully cure prior to the contact lens formulation being dispensed into the coated mold. In other examples, the contact lens coating composition is applied onto the PVOH-coated contact lens mold and the contact lens formulation is dispensed into the coated mold without any pre-curing step. In some examples, a single contact lens coating composition is applied onto the PVOH-coated contact lens mold. In other examples, two or more contact lens coating compositions may be sequentially applied to the PVOH-coated contact lens mold where each applied contact lens coating composition are the same or different. For example, a first contact lens coating composition may be applied onto the PVOH-coated mold, then a second contact lens coating composition may be applied on top of the first contact lens coating composition. In this example, the second contact lens coating composition may comprise a component that reacts or interacts with a component of the first contact lens coating composition, such as by chemical or physical interactions as described below.

In one example, the contact lens coating composition comprises one or more monomers that, when cured, form a polymer coating on the polymeric lens body. The term “monomer”, as used herein, refers to any molecule comprising at least one polymerizable group (e.g. vinyl group, acrylate group, methacrylate group, etc.) capable of reacting with other molecules that are the same or different, to form a polymer or copolymer. In one example, a polymerizable contact lens coating composition comprises a cross-linking agent, which is a monomer comprising two or more polymerizable groups. In such example, a cross-linked polymer coating may form that is physically interconnected with the polymeric lens body at its surface. An interpenetrating polymer network may form at the interface of the polymer coating and the polymeric lens body. In some examples, a contact lens coating composition may comprise monomers that copolymerize with monomers of the contact lens formulation so that the resulting contact lens comprises a coating that is covalently attached to the polymeric lens body. In some examples, the coating may be attached to the polymeric lens body covalently and by an interpenetrating polymer network.

In some examples, the contact lens coating composition may comprise a molecule comprising a functional group that reacts with a complementary functional group on a component of the contact lens formulation. For example, an amine-containing molecule in the contact lens formulation may react with an N-hydroxysuccinimide (NHS) group present on a component, such as an NHS-functionalized hydrophilic polymer, of the contact lens coating composition to provide a contact lens comprising a polymeric lens body with a hydrophilic polymer coating covalently attached at its surface. Other combinations of complementary functional groups suitable for covalently attaching desirable components onto the surfaces of contact lenses are generally known in the art (see. e.g. U.S. Pat. No. 9,310,627). In another example, the component of the contact lens coating composition comprises an ionic group that forms an ionic bond with a complementary ionic group present on a component of the contact lens formulation. For example, a contact lens formulation may comprise a monomer comprising a carboxylic acid group that forms an ionic bond with an amine group present on a component of the contact lens coating composition. Thus, it will be appreciated that, in some examples, the resulting contact lens may have a surface coating that is attached to the polymeric lens body by chemical bonding, such as covalent bonding, hydrogen bonding or ionic bonding. In other examples, the surface coating may be attached to the polymeric lens body through physical interactions, such as through formation of an interpenetrating polymer network, as described previously, or through hydrophobic-hydrophobic interactions. In some examples, the contact lens coating composition comprises a component, such as a drug or comfort agent, that non-covalently attaches to the polymeric lens body and releases from the contact lens when worn by a patient.

In one example, the contact lens coating composition comprises a cross-linked polymer. In a specific example, the cross-linked polymer is a particulate polymer. As used herein, the term particulate polymer refers to a very high molecular weight cross-linked polymer having a diameter of at least about 0.01 μm. In some examples, a particulate polymer used in a contact lens coating composition may have an average diameter of at least 0.01 μm, 0.05 μm, or 0.1 μm, and up to about 0.5 μm or 1 μm. As used herein, the diameter of a particulate polymer refers to the diameter of a single polymer molecule. It will be appreciated that a particulate polymer may be provided as a flocculent in which individual particulate polymers are aggregated to form larger particles sizes. Thus, the contact lens coating composition may comprise particulate polymer aggregates having a size of up to about 5 μm or 10 μm or more. In specific examples, the particulate polymer is a homopolymer or a copolymer of acrylic acid. Examples of particulate polymers of acrylic acid include Carbopol® and Pemulen™ polymers from Lubrizol. Carbopol® homopolymers comprise acrylic acid crosslinked with allyl sucrose or allyl pentaerythritol. Carbopol® and Pemulen™ copolymers comprise acrylic acid and C10-C30 alkyl acrylate crosslinked with polyalkenyl ethers or divinyl glycol. In a specific example, the particulate polymer is an amphiphilic polymer and the polymeric lens body is a silicone hydrogel or a silicone elastomer. In one such example, the amphiphilic polymer may be a block copolymer.

After the contact lens coating composition has been coated onto the contact lens mold, and optionally dried, the coated contact lens mold may be used to cure any type of contact lens formulation. In one example, the contact lens formulation comprises at least one siloxane, which is a molecule comprising at least one Si—O—Si group. In one example, the siloxane-containing contact lens formulation, when cured, forms a silicone elastomer. Silicone elastomers, which are also referred to in the art as silicone rubbers, are materials based on polyorganosiloxanes, such as, for example, polydimethylsiloxane (PDMS). A silicone elastomer may have a water content of less than 1 wt. %, or less than 0.5 wt. %, or less than 0.3 wt. %. Curable formulations comprising PDMS that are suitable for use in contact lens formulations include MED6015, MED 6755 and MED6033, from NuSil Technology, and SYLGARD elastomers from Dow Corning. These formulations may be dispensed into a PVOH-coated contact lens molds and cured in accordance with the manufacturer's specifications.

In another example, the siloxane-containing contact lens formulation forms a silicone hydrogel. A silicone hydrogel contact lens typically has a water content of at least about 10 wt. %, 20 wt. %, 30 wt. %, or 40 wt. % and up to about 50 wt. %, 60 wt. % or 70 wt. %. Contact lens formulations for silicone hydrogels typically comprise at least one siloxane monomer and at least one hydrophilic monomer.

Siloxane monomers suitable for use in silicone hydrogel contact lens formulations are well-known in the art and include, 3-[tris(trimethylsiloxy)silyl]propyl methacrylate, 3-methacryloxy-2-hydroxypropyloxy)propylbis(trimethylsiloxy)methylsilane, methyldi(trimethylsiloxy)sylylpropylglycerolethyl methacrylate, and monomethacryloxypropyl functional polydimethylsiloxanes such as MCR-M07 and MCS-M11, all available from Gelest (Morrisville, Pa., USA). Additional suitable siloxane monomers are well known in the art. Exemplary siloxane monomers and contact lens formulations are described in U.S. Pat. No. 8,129,442, U.S. Pat. No. 8,614,261, and U.S. Pat. No. 8,865,789.

Exemplary hydrophilic monomers for use in silicone hydrogel contact lens formulations include N-vinyl-N-methylacetamide, N-vinyl pyrrolidone, 1,4-butanediol vinyl ether, ethylene glycol vinyl ether, diethylene glycol vinyl ether, or N,N-dimethylacrylamide, 2-hydroxyethyl methacrylate, ethoxyethyl methacrylamide, ethylene glycol methyl ether methacrylate, or any combinations thereof. A silicone hydrogel contact lens formulation typically comprises a cross-linking agent, which is a monomer having two or more polymerizable groups. Silicon hydrogel contact lens formulations are well known in the art (see e.g. U.S. Pat. No. 8,865,789, and U.S. Pat. No. 8,231,218).

As will be appreciated by those skilled in the art, the contact lens formulation may comprise additional polymerizable or non-polymerizable ingredients conventionally used in contact lens formulations such as one or more of a polymerization initiator, a UV absorbing agent, a tinting agent, an oxygen scavenger, a chain transfer agent, or the like. In some examples, a contact lens formulation for a silicone hydrogel may include an organic diluent in an amount to prevent or minimize phase separation between the hydrophilic and hydrophobic components of the formulation, so that an optically clear lens is obtained.

The contact lens formulation is dispensed into the coated contact lens mold and cured using any suitable curing method. Typically the contact lens formulation comprises a thermal initiator or a photoinitiator that initiates curing or polymerization of the contact lens formulation upon exposure to heat or ultraviolet (UV) light. In the case of UV-curing, also referred to as photopolymerization, the contact lens formulation typically comprises a photoinitiator such as benzoin methyl ether, 1-hydroxycyclohexylphenyl ketone, DAROCUR, or IRGACUR (available from Ciba Specialty Chemicals). In the case of heat-curing, also referred to as thermal curing, the polymerizable composition typically comprises a thermal initiator. Exemplary thermal initiators include 2,2′-azobis(2,4-dimethylpentanenitrile) (VAZO-52), 2,2′-Azobis(2-methylpropanenitrile) (VAZO-64), and 1,1′-azo bis(cyanocyclohexane) (VAZO-88). Various methods for curing contact lens formulations are well known in the art (see e.g. U.S. Pat. No. 8,231,218, U.S. Pat. No. 7,854,866, and U.S. Pat. No. 5,760,100).

At the completion of curing, the male and female mold members are separated (i.e. demolded) and the contact lens, which comprises a polymeric lens body and a surface coating attached to the polymeric lens body, is removed from the mold member (i.e. delensed). Methods for delensing contact lenses are well-known in the art (see e.g. U.S. Pat. No. 7,811,483, and U.S. Pat. No. 9,102,110). The contact lens is then washed in a process referred to as extraction and hydration, which removes unreacted or partially reacted ingredients from the polymeric lens body and, in the case of hydrogel contact lenses, hydrates the polymeric lens body. The washing step involves contacting the polymeric lens body with one or more volumes of one or more washing liquids, which may comprise one or more volatile organic solvents (e.g., methanol, ethanol, chloroform, or the like) and/or water. An exemplary extraction and hydration process for a cured silicone hydrogel contact lens comprises removing the lens from its mold and placing it into two exchanges of ethanol, then one exchange of 50:50 (by volume) ethanol:deionized water, and finally two exchanges of deionized water, where in each exchange the lens is soaked in 2 ml liquid at 25° C. for 30 minutes, for a total wash time of 150 minutes. The washing process typically removes some or substantially all of the outer coating of PVOH that remains adhered to the contact lens after demolding. Thus, in some examples, the surface of the contact lens is substantially free of PVOH. As used herein, a surface coating is substantially free of PVOH if less than 5% of the atomic mass of the surface coating to a depth of 10 Å is comprised of PVOH as determined by standard analytical methods, for example, such as by time-of-flight secondary ion mass spectrometry (TOF-SIMS). In some examples, the surface coating comprises less than 2% PVOH or less than 1% PVOH. In other examples, the presence of PVOH on the surface of the contact lens is not detectable.

The PVOH coating on the mold can prevent the contact lens coating composition from being solubilized or absorbed by the contact lens formulation during the curing step, resulting in the formation of a relatively even coating on the surface of the contact lens compared to that of a control lens. In this context, a “control lens” refers to a lens made from the same contact lens formulation and contact lens coating composition, and manufactured using the same method except that the contact lens coating composition is coated directly onto an uncoated, but otherwise identical, contact lens mold. The evenness of the surface coating on the contact lens can be visualized by staining the lens with a dye that binds to the surface coating. An even coating is one that stains uniformly, whereas an uneven coating is evident by blotchy or otherwise uneven staining. In some cases, a control lens may be misshapen or have a defective surface (e.g. wrinkled, bumpy, etc.), whereas the same contact lens formulation and contact lens coating composition provides a defect-free lens when cured in a PVOH-coated mold. In this example, the presence of an even coating on the surface of the contact lens can be inferred without having to stain the lens.

The mold transfer method described herein for forming surface coatings on contact lenses may be used for coating any type of contact lens material. The method is particularly useful for forming hydrophilic coatings onto silicone hydrogel or silicone elastomer contact lenses, as it enables the formation of thick, durable, hydrophilic coatings that can't otherwise be achieved using available post-cure methods for coating such lenses. In one example, the surface coating of the contact lens has a thickness of at least 1 μm, 5 μm, or 10 μm up to about 25 μm, 50 μm or 75 Coating thickness can be measured by atomic force microscopy and confocal microscopy, or any other suitable analytical method known in the art. In various examples, the surface coating of the contact lens is durable, which, as used herein, means that the coating does not come off the lens when it is rubbed for 10 seconds between fingers, as is typically done for cleaning purposes.

In some examples where the contact lens coating composition comprises a hydrophilic component, the contact lens exhibits an advancing contact angle that is less than that of a control contact lens, wherein a “control lens”, in this context, refers to a lens made from the same contact lens formulation and manufactured using the same method and mold except that the mold has been coated with only PVOH (i.e. it is not coated with the contact lens coating composition). In some examples, the contact lens exhibits an advancing contact angle that is at least 5°, 10°, 15°, or 20° lower than that of the control lens. As used herein, the advancing contact angle of a contact lens is measure by captive bubble method using a KRUSS Drop Shape Analyzer 100, or equivalent method.

After washing, and any optional process step (e.g. surface modification to attach a beneficial agent to the surface coating of the contact lens), the contact lens is placed into a blister package, glass vial, or other appropriate container, all referred to herein as “packages.” Typically, packaging solution is also added to the container. Suitable packaging solutions include phosphate- or borate-buffered saline together with any optional additional ingredients such as a comfort agent, a medication, a surfactant to prevent the lens from sticking to its package, or the like. The package is sealed and sterilized by radiation, heat or steam (e.g., autoclaving), gamma radiation, e-beam radiation, or the like. In some examples, the contact lens may be packaged under sterile conditions, making a post-packaging sterilization step unnecessary. In a specific example, the sealed contact lens package is sterilized by autoclaving.

In one example, the manufacturing method disclosed herein provides a silicone hydrogel contact lens comprising a polymeric lens body and a surface coating comprising a cross-linked acrylic acid polymer attached to the polymeric lens body by an interpenetrating polymer network. In a specific example the acrylic acid polymer has a diameter of at least about 0.01 μm. In a further example, the acrylic acid polymer comprises a copolymer of acrylic acid and a C10-C30 alkyl acrylate. In a further example the polymeric lens body is substantially free of positively charged groups such that the cross-linked acrylic acid polymer is not ionically attached to the polymeric lens body. The silicone hydrogel contact lens may be provided in a sealed package. The sealed package may comprise one or more molecules comprising cationic groups that ionically attach to the cross-linked acrylic acid polymer that is attached to the polymeric lens body.

The following Examples illustrate certain aspects and advantages of the present invention, which should be understood not to be limited thereby.

### Example 1: Mold Transfer of Hydrophilic Coatings onto Silicone Hydrogel Contact Lenses

Male and female mold pairs were wetted by a 10% PVOH (MW 89,000, 99% hydrolyzed) solution in water. This was done by filling each mold pair with 50 μL of the PVOH solution, gently closing and then separating the mold pair. Each male and female mold half was spun for approximately 20 seconds at 8,800 RPM via a Maxon motor running EPOS studio software. Molds were dried at room temperature for 1 hour to 1 day prior to use. Each mold half had a PVOH film thickness in the range of 250 nm to 5 urn as determined by spectral reflectance (F20, Filmetrics).

Two contact lens coating compositions were prepared as follows. The first contact lens coating composition, referred to herein as the Gantrez™-containing coating composition comprised 5% ethanol-reacted Gantrez™ AN-169 and 0.1% RB19-HEMA. Gantrez™ AN-169 is a copolymer of methyl vinyl ether and maleic anhydride, which upon reaction with ethanol forms a polymer of the following structure:

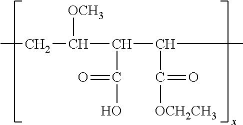

RB19-HEMA is Reactive Blue 19 covalently attached to hydroxyethyl methacrylate (see U.S. Pat. No. 8,865,929) and has the following structure:

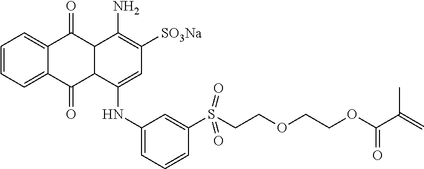

The second contact lens coating composition, referred to herein as the PVP-containing coating composition, was made by dissolving 10% polyvinyl pyrrolidone (Kollidon 90), 1% itaconic acid, and 0.1% RB19-HEMA in ethanol. PVOH-coated and uncoated polypropylene contact lens mold halves were spun at approximately 8,800 RPM and 1 drop (˜20 μl) of a coating composition was dropped via a pipette onto the spinning mold half. The mold halves were allowed to spin for about 20 seconds. Both the Gantrez™-containing and the PVP-containing coating compositions were observed to spread evenly onto both PVOH-coated and uncoated molds.

A curable formulation for comfilcon A contact lenses was dispensed into the coated and uncoated molds and UV cured at 50 μW/cm² for 1 hour. After curing, the lenses were removed from their molds and the appearance of the dry lenses was noted. Lenses that were cured in polypropylene molds coated directly with the Gantrez™-containing coating composition or the PVP-containing coating composition were yellow, indicating that the coating composition had absorbed into the contact lens composition. The surfaces of these lenses were bumpy and uneven. In contrast, the surfaces of lenses cured in PVOH-coated molds were even and smooth. The lens cured with the Gantrez™-containing coating composition was bluish green, indicating partial absorption by the contact lens composition. The lens cured with the PVP-containing coating composition was yellow, indicating absorption by the contact lens composition.

All the lenses were washed with deionized water for 15 minutes, followed by ethanol for four 15 minute washes. The lenses were then packaged in phosphate buffered saline and autoclaved. All of the lenses that were cured in PVOH-coated molds yielded highly wettable lenses, while the lenses that were cured in polypropylene molds coated directly with the contact lens coating composition resulted in lenses with non-wettable regions.

Lenses coated with Gantrez were soaked in pH 9 deionized water for 15 minutes. These lenses and the PVP-coated lenses were submerged into 1 mg/mL Toluidine Blue 0 (TBO). TBO binds carboxylic acid groups, which were present in both coating compositions. The lenses were rinsed repeatedly over the course in pH 9 water. Gantrez-coated lenses that were cured in non-PVOH coated molds were misshapen (curled). They were stained blue and punctuated with darker blue areas. In contrast, the Gantrez-coated lenses that were cured in PVOH-coated molds were not misshapen and were evenly stained dark blue. Similarly, the PVP-coated lenses that were cured in molds without PVOH were curled and stained an uneven blue, whereas PVP-coated lenses cured in PVOH-coated molds were not misshapen and had an even dark blue staining.

The results demonstrate that a coating of PVOH onto a contact lens mold can enable the transfer of a uniform layer of a contact lens coating material onto a contact lens to provide a lens with an even coating. Without the PVOH coating, the contact lens coating material can mix with the contact lens composition resulting in misshapen lenses with defective surfaces.

### Example 2: Mold Transfer of Distinctive Patterns onto Silicone Hydrogel Contact Lenses

The PVP-coating composition prepared in Example 1 was applied to PVOH-coated molds in patterns. In one case, the PVP-coating composition was spun onto the mold to form a star shape. In another example, the PVP-coating composition was painted onto the mold in three distinct oval shapes. The molds were used to cure the composition for comfilcon A contact lenses, as described in Example 1. After curing, the star and oval patterns that had been applied to the molds were apparent on the dry lenses. The star pattern was yellow, indicating reaction with the lens monomer mix, yet the pattern remained distinct and not diffuse. The oval patterns were mostly blue with some yellow, indicating that the monomer mix did not fully penetrate the PVP coating. After washing and autoclaving the patterns were very light blue in color and remained distinct.

The results further illustrate that the PVOH layer helps prevent the contact lens coating composition from being solubilized by the contact lens composition and further illustrate that the method can be used to transfer colored patterns on silicone hydrogel contact lenses.

### Example 3: Mold Transfer of a Cross-Linked Polymer onto Silicone Hydrogel Contact Lenses

A 1% solution of Pemulen™ TR-2NF in ethanol was spin-coated onto uncoated or PVOH-coated polypropylene molds. The PVOH-coated molds were prepared as described in Example 1. 20 μl of the Pemulen™ solution was dropped onto a mold spinning at 8800 RPM and spun for another 5 to 10 seconds, then dried for 30 minutes to 1 day before use.

A silicone hydrogel contact lens formulation was prepared by mixing together about 38 parts of a monomethacryloxypropyl functional polydimethylsiloxane having an average molecular weight of about 900, about 20 parts methyl bis(trimethylsiloxy)silyl propyl glycerol methacrylate, about 40 parts N,N-dimethylacrylamide (DMA), about 1 part triethylene glycol dimethacrylate, less than 1 part thermal initiator (VAZO-64), and less than 1 part triphenylphosphine. The composition was dispensed into uncoated polypropylene molds or polypropylene molds coated with either PVOH and Pemulen or just PVOH, prepared as described above. The filled molds were thermally cured in an air oven (i.e., without N₂) at 55° C., 80° C., and 100° C. for 40 minutes each.

After curing, the lenses were washed in water alone or in ethanol (EtOH) and water. For water washing, each lens was placed in 3 mL deionized water for 10 minutes each exchange without agitation. For EtOH washing, each lens was placed in 3 mL EtOH for 30 minutes—two exchanges, followed by placement in 3 ml of 50% EtOH (in DI H₂O) for 30 minutes, with three final exchanges in DI H₂O for 10 minutes each exchange. The washed lenses were placed into vials containing 4 ml PBS, capped, and autoclaved. The autoclaved lenses were removed from the vials. All lenses were clear and free of visible deformations such as wrinkles and wavy edges.

The dynamic, advancing contact angle of each lens (n=3) was measured by captive bubble method using a KRUSS Drop Shape Analyzer 100. The results are shown in Table 1.

TABLE 1

| | Contact Angle | Contact Angle |
|---|---|---|
| Coating | DI H₂O Wash | ETOH Wash |
| Uncoated | 97° | 100° |
| PVOH | 82° | 63° |
| Pemulen ™ | 65° | 74° |
| PVOH + Pemulen ™ | 47° | 56° |

The disclosure herein refers to certain illustrated examples, it is to be understood that these examples are presented by way of example and not by way of limitation. The intent of the foregoing detailed description, although discussing exemplary examples, is to be construed to cover all modifications, alternatives, and equivalents of the examples as may fall within the spirit and scope of the invention as defined by the additional disclosure.

The entire contents of all cited references in this disclosure, to the extent that they are not inconsistent with the present disclosure, are incorporated herein by reference.

The present invention includes the following aspects/embodiments/features in any order and/or in any combination:
1. A method of manufacturing a contact lens, said method comprising:
   a) coating a polyvinyl alcohol polymer on at least a portion of a lens-forming surface of a contact lens mold;
   b) applying a contact lens coating composition onto at least a portion of the polyvinyl alcohol polymer to provide a coated contact lens mold;
   c) curing a contact lens formulation in the coated contact lens mold to form a contact lens comprising a polymeric lens body and a surface coating attached to the polymeric lens body, wherein the surface coating comprises at least one component of the contact lens coating composition.
2. The method of any preceding or following embodiment/feature/aspect, wherein the lens-forming surface of the contact lens mold is non-polar.
3. The method of any preceding or following embodiment/feature/aspect, wherein the lens-forming surface of the contact lens mold comprises polypropylene.
4. The method of any preceding or following embodiment/feature/aspect, wherein the polyvinyl alcohol polymer is a homopolymer having a molecular weight of about 20,000 to about 150,000.
5. The method of any preceding or following embodiment/feature/aspect, wherein the polyvinyl alcohol polymer is at least 95% hydrolyzed.
6. The method of any preceding or following embodiment/feature/aspect, wherein the polyvinyl alcohol polymer is applied by spin-coating or spray-coating.
7. The method of any preceding or following embodiment/feature/aspect, wherein the at least one component of the contact lens coating composition is a hydrophilic monomer, a hydrophilic polymer, an amphiphilic polymer, a polymerizable dye, a drug, a comfort agent, an antimicrobial agent, or any combinations thereof
8. The method of any one of any preceding or following embodiment/feature/aspect, wherein the at least one component of the contact lens coating composition comprises a cross-linked polymer particle.
9. The method of any preceding or following embodiment/feature/aspect, wherein the cross-linked polymer particle comprises an acrylic acid polymer.
10. The method of any preceding or following embodiment/feature/aspect, wherein the contact lens coating composition comprises an amphiphilic polymer.
11. The method of any preceding or following embodiment/feature/aspect, wherein the contact lens composition comprises at least one siloxane.
12. The method of any preceding or following embodiment/feature/aspect, wherein the polymeric lens body comprises a silicone elastomer.
13. The method of any one of any preceding or following embodiment/feature/aspect, wherein the polymeric lens body comprises a silicone hydrogel.
14. The method of any preceding or following embodiment/feature/aspect, wherein the surface coating is substantially free of polyvinyl alcohol polymer.
15. The method of any preceding or following embodiment/feature/aspect, wherein the surface coating comprises a polymer attached to the polymeric lens body by an interpenetrating polymer network.
16. The method of any preceding or following embodiment/feature/aspect, wherein the surface coating is covalently attached to the polymeric lens body.
17. A contact lens prepared by the method of any one of any preceding or following embodiment/feature/aspect.
18. A silicone hydrogel contact lens comprising a polymeric lens body and a surface coating comprising a cross-linked acrylic acid polymer attached to the polymeric lens body by an interpenetrating polymer network.
19. The silicone hydrogel contact lens of any preceding or following embodiment/feature/aspect, wherein the acrylic acid polymer has a diameter of at least 0.01 μm.

The present invention can include any combination of these various features or embodiments above and/or below as set forth in sentences and/or paragraphs. Any combination of disclosed features herein is considered part of the present invention and no limitation is intended with respect to combinable features.

Applicant specifically incorporates the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A method of manufacturing a contact lens, said method comprising:
a) coating a polyvinyl alcohol polymer on at least a portion of a lens-forming surface of a contact lens mold;
b) applying a contact lens coating composition onto at least a portion of the polyvinyl alcohol polymer to provide a coated contact lens mold;
c) curing a contact lens formulation in the coated contact lens mold to form a contact lens comprising a polymeric lens body and a surface coating attached to the polymeric lens body, wherein the surface coating comprises at least one component of the contact lens coating composition.

2. The method of claim 1, wherein the lens-forming surface of the contact lens mold is non-polar.

3. The method of claim 1, wherein the lens-forming surface of the contact lens mold comprises polypropylene.

4. The method of claim 1, wherein the polyvinyl alcohol polymer is a homopolymer having a molecular weight of about 20,000 to about 150,000.

5. The method of claim 4, wherein the polyvinyl alcohol polymer is at least 95% hydrolyzed.

6. The method of claim 1, wherein the polyvinyl alcohol polymer is applied by spin-coating or spray-coating.

7. The method of claim 1, wherein the at least one component of the contact lens coating composition is a hydrophilic monomer, a hydrophilic polymer, an amphiphilic polymer, a polymerizable dye, a drug, a comfort agent, an antimicrobial agent, or any combinations thereof.

8. The method of claim 1, wherein the at least one component of the contact lens coating composition comprises a cross-linked polymer particle.

9. The method of claim 8, wherein the cross-linked polymer particle comprises an acrylic acid polymer.

10. The method of claim 1, wherein the contact lens coating composition comprises an amphiphilic polymer.

11. The method of claim 1, wherein the contact lens composition comprises at least one siloxane.

12. The method of claim 1, wherein the polymeric lens body comprises a silicone elastomer.

13. The method of claim 1, wherein the polymeric lens body comprises a silicone hydrogel.

14. The method of claim 1, wherein the surface coating is substantially free of polyvinyl alcohol polymer.

15. The method of claim 1, wherein the surface coating comprises a polymer attached to the polymeric lens body by an interpenetrating polymer network.

16. The method of claim 1, wherein the surface coating is covalently attached to the polymeric lens body.

17. A contact lens prepared by the method of claim 1.

18. A silicone hydrogel contact lens comprising a polymeric lens body and a surface coating comprising a cross-linked acrylic acid polymer attached to the polymeric lens body by an interpenetrating polymer network.

19. The silicone hydrogel contact lens of claim 18, wherein the acrylic acid polymer has a diameter of at least 0.01 μm.
